(19) United States
(12) Patent Application Publication
(10) Pub. No.: US 2020/0143546 A1
(43) Pub. Date: May 7, 2020

(54) APPARATUS AND METHOD FOR DETECTING SLOW VEHICLE MOTION

(71) Applicant: GM GLOBAL TECHNOLOGY OPERATIONS LLC, Detroit, MI (US)

(72) Inventors: Syed B. Mehdi, Farmington Hills, MI (US); Yasen Hu, Warren, MI (US)

(21) Appl. No.: 16/180,743

(22) Filed: Nov. 5, 2018

(51) Int. Cl. G06T 7/246; B60Q 9/00; B60N 2/90; G06T 7/564

(52) U.S. Cl. CPC G06T 7/248; B60Q 9/008; B60N 2/90; G06T 2207/20016; B60N 2002/981; G06T 2207/30252; G06T 7/564

(57) ABSTRACT

A method and apparatus for detecting motion of a slow-moving vehicle are provided. The method includes detecting a wheel of the vehicle in a plurality of frames of a video, generating bounding boxes around portions of the frames including the wheel of the vehicle, scaling the portions of the frames including the wheel of the vehicle to a predetermined constant size, determining whether the wheel of the vehicle is moving by analyzing the scaled portions of the image, and outputting information indicating that the vehicle is moving if the determining determines that the wheel of the vehicle is moving.

### INTRODUCTION

Apparatuses and methods consistent with exemplary embodiments relate to detecting vehicle motion. More particularly, apparatuses and methods consistent with exemplary embodiments relate to detecting the motion of a vehicle traveling at slow speeds.

### SUMMARY

One or more exemplary embodiments provide a method and an apparatus that detect slow moving vehicles by using video images. More particularly, one or more exemplary embodiments provide a method and an apparatus that detect slow moving vehicles by analyzing wheel video images to detect wheels and the motion of detected wheels.

According to an aspect of an exemplary embodiment, a method for detecting motion of a slow-moving vehicle is provided. The method includes detecting a wheel of the vehicle in a plurality of frames of a video, generating bounding boxes around portions of the frames including the wheel of the vehicle, scaling the portions of the frames including the wheel of the vehicle to a predetermined constant size, determining whether the wheel of the vehicle is moving by analyzing the scaled portions of the frames, and outputting information indicating that the vehicle is moving if the determining determines that the wheel of the vehicle is moving.

The determining whether the wheel of the vehicle is moving may include determining whether the wheel of the vehicle is rotating.

The determining whether the wheel of the vehicle is moving may further include determining a direction of movement of the wheel.

The outputting information may include providing a notification indicating that the vehicle is moving if the determining determines that the vehicle is moving in a direction that will obstruct a path of a host vehicle.

The notification may include at least one from among displaying an alternate path for the host vehicle, haptic feedback via a seat in a host vehicle, and displaying a warning associated with the moving vehicle on a display in the host vehicle.

The analyzing the scaled portions of the image may include identifying a plurality of feature points corresponding to the wheel of the vehicle in the frames of the image and determining changes in coordinates of the plurality of features points in the frames of the image.

The determining changes in coordinates of the plurality of features points in the frames of the image may include calculating a change in angle with respect to the identified plurality of feature points.

The analyzing the scaled portions of the image may include identifying a shape corresponding to the wheel of the vehicle in the frames of the image and determining changes in coordinates of the identified shape in the frames of the image.

The identifying the shape may include performing one or more from among edge detection, line detection, and ellipse or circle detection. The wheel may include a plurality of wheels.

The method may also include controlling a host vehicle to change a path based on the information indicating that the vehicle is moving.

According to an aspect of another exemplary embodiment, an apparatus for detecting motion of a slow-moving vehicle is provided. The apparatus includes at least one memory including computer executable instructions; and at least one processor configured to read and execute the computer executable instructions. The computer executable instructions cause the at least one processor to detect a wheel of the vehicle in a plurality of frames of a video, generate bounding boxes around portions of the frames including the wheel of the vehicle, scale the portions of the frames including the wheel of the vehicle to a predetermined constant size, determine whether the wheel of the vehicle is moving by analyzing the scaled portions of the frames, and output information indicating that the vehicle is moving if the determining determines that the wheel of the vehicle is moving.

The computer executable instructions cause the at least one processor to determine whether the wheel of the vehicle is moving by determining whether the wheel of the vehicle is rotating.

The computer executable instructions may cause the at least one processor to determine whether the wheel of the vehicle is moving by determining a direction of movement of the wheel.

The computer executable instructions may cause the at least one processor to output information by providing a notification indicating that the vehicle is moving if the determining determines that the vehicle is moving in a direction that will obstruct a path of a host vehicle.

The notification may include at least one from among displaying an alternate path for the host vehicle, haptic feedback via a seat in a host vehicle, and displaying a warning associated with the moving vehicle on a display in the host vehicle.

The computer executable instructions further cause the at least one processor to analyze the scaled portions of the image by identifying a plurality of feature points corresponding to the wheel of the vehicle in the frames of the image and determining changes in coordinates of the plurality of features points in the frames of the image.

The computer executable instructions cause the at least one processor to determine changes in coordinates of the plurality of features points in the frames of the image by calculating a change in angle with respect to the identified plurality of feature points.

The computer executable instructions cause the at least one processor to analyze the scaled portions of the image by identifying a shape corresponding to the wheel of the vehicle in the frames of the image and determining changes in coordinates of the identified shape in the frames of the image.

The computer executable instructions cause the at least one processor to identify the shape by performing one or more from among edge detection, line detection, and ellipse or circle detection.

The wheel may be a plurality of wheels.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that detects motion of a slow-moving vehicle according to an exemplary embodiment;

FIG. 2 shows a flowchart for a method of detecting motion of a slow-moving vehicle according to an exemplary embodiment;

FIG. 3 shows an illustration of generating bounding boxes and identifying feature points on a wheel of a vehicle according to an aspect of an exemplary embodiment; and

FIG. 4 shows illustrations of notifications warning of a slow-moving vehicle in a parking lot according to an aspect of an exemplary embodiment.

### DETAILED DESCRIPTION OF EXEMPLARY EMBODIMENTS

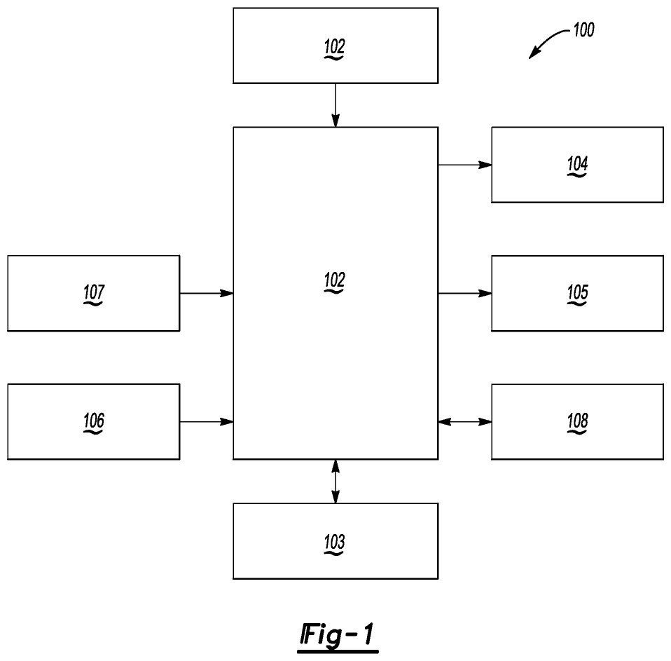

An apparatus and method that detects the motion of a slow-moving vehicle will now be described in detail with reference to FIGS. 1-4 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Vehicles now include many sensor and cameras. For example, a host vehicle may include cameras capture images of areas all around the host vehicle. Moreover, vehicles may also include radars configured to detect external obstacles or moving objects that may be a potential collision hazard for a host vehicle. One issue with sensors such as radars and lidars is that they may not have the resolution or precision necessary to accurately detect movement of a slow-moving external vehicle especially when the motion is perpendicular to the line of sight of the host vehicle and/or the host vehicle is moving quickly, for example, in a parking lot driving, stop sign intersections, and in neighborhood driveways.

To address the above issue, cameras may be relied upon to detect the movement of slow moving obstacles or objects by using a relative location of moving objects. However, the video information provided by a camera needs to be processed and analyzed to determine whether an obstacle or object, such as an external vehicle, is moving and the direction of movement for better detection. The apparatus detects the motion of a slow-moving vehicle identifies wheels in a video image, processes and analyzes frames including an image of the identified wheels in order to determine movement of the obstacle or object such as the slow-moving external vehicle. Moreover, wheel rotation instead of a relative location of a wheel or object in a frame can be used to determine movement.

FIG. 1 shows a block diagram of an apparatus that detects the motion of a slow-moving vehicle 100 according to an exemplary embodiment. As shown in FIG. 1, the apparatus that detects the motion of a slow-moving vehicle 100, according to an exemplary embodiment, includes a controller 101, a power supply 102, a storage 103, an output 104, host vehicle controls 105, a user input 106, an image sensor 107, and a communication device 108. However, the apparatus that detects the motion of a slow-moving vehicle 100 is not limited to the aforementioned configuration and may be configured to include additional elements and/or omit one or more of the aforementioned elements. The apparatus that detects the motion of a slow-moving vehicle 100 may be implemented as part of a vehicle, as a standalone component, as a hybrid between an on vehicle and off vehicle device, or in another computing device.

The controller 101 controls the overall operation and function of the apparatus that detects the motion of a slow-moving vehicle 100. The controller 101 may control one or more of a storage 103, an output 104, the host vehicle controls 105, a user input 106, an image sensor 107, and a communication device 108 of the apparatus that detects the motion of a slow-moving vehicle 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the storage 103, the output 104, the host vehicle controls 105, the user input 106, the image sensor 107, and the communication device 108 of the apparatus that detects the motion of a slow-moving vehicle 100. The information may be sent and received via a bus or network, or may be directly read or written to/from one or more of the storage 103, the output 104, the user input 106, the image sensor 107, and the communication device 108 of the apparatus that detects the motion of a slow-moving vehicle 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the controller 101, the storage 103, the output 104, the host vehicle controls 105, the user input 106, the image sensor 107, and the communication device 108, of the apparatus that detects the motion of a slow-moving vehicle 100. The power supply 102 may include one or more from among a battery, an outlet, a capacitor, a solar energy cell, a generator, a wind energy device, an alternator, etc.

The storage 103 is configured for storing information and retrieving information used by the apparatus that detects the motion of a slow-moving vehicle 100. The storage 103 may be controlled by the controller 101 to store and retrieve information received from the image sensor 107. The stored information may include image information captured by the image sensor 107 including information on visual features, objects, structures, object movement, etc. The image information may include video images with a plurality of frames of video of an area around the vehicle. Moreover, the stored information may also include convolutional neural networks used to identify objects, structures, visual features, etc. The storage 103 may also include the computer instructions configured to be executed by a processor to perform the functions of the apparatus that detects the motion of a slow-moving vehicle 100.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the apparatus that detects the motion of a slow-moving vehicle 100. The output 104 may include one or more from among a speaker, an audio device, a display, a centrally-located display, a head up display, a windshield display, a haptic feedback device, a vibration device, a tactile feedback device, a tap-feedback device, a holographic display, an instrument light, an indicator light, etc.

The output 104 may output notification including one or more from among an audible notification, a light notification, a haptic notification and a display notification. The notification may include displaying an alternate route for a host vehicle, providing haptic feedback via a vibration device in a seat of the host vehicle, or displaying a warning associated with the moving vehicle on a display in the host vehicle. The warning may be a graphic symbol displayed on or near the moving vehicle on a display.

The host vehicle controls 105 may include vehicle system modules (VSMs) in the form of electronic hardware components that are located throughout the vehicle and typically receive input from one or more sensors and use the sensed input to perform diagnostic, monitoring, control, reporting and/or other functions. Each of the VSMs may be connected by a communications bus to the other VSMs, as well as to the controller 101, and can be programmed to run vehicle system and subsystem diagnostic tests. The controller 101 may be configured to send and receive information from the VSMs and to control VSMs to perform vehicle functions. As examples, one VSM can be an engine control module (ECM) that controls various aspects of engine operation such as fuel ignition and ignition timing, another VSM can be an external sensor module configured to receive information from external sensors such as cameras, radars, LIDARs, and lasers, another VSM can be a powertrain control module that regulates operation of one or more components of the vehicle powertrain, another VSM can be the vehicle dynamics sensor that detects a steering wheel angle parameter, a speed parameter, an acceleration parameter, a lateral acceleration parameter, a self-aligning torque parameter and/or a power steering torque parameter, and another VSM can be a body control module that governs various electrical components located throughout the vehicle, like the vehicle's power door locks and headlights. As is appreciated by those skilled in the art, the above-mentioned VSMs are only examples of some of the modules that may be used in a vehicle, as numerous others are also available.

The user input 106 is configured to provide information and commands to the apparatus that detects the motion of a slow-moving vehicle 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc. The user input 106 may be configured to receive a user input to acknowledge or dismiss the notification output by the output 104. Moreover, the user input 106 may also be configured to receive an input activate or deactivate the apparatus that detects the motion of a slow-moving vehicle 100.

The image sensor 107 may include one or more from among a plurality of sensors including an imaging sensor, a camera, an infrared camera, and a video camera. The image sensor 107 may provide one or more images or frames from one or more cameras or image sensors facing the area all around the vehicle. The frames or the images that may be analyzed to identify wheels, vehicles, features points, shapes, edges, lines.

In one example, the focal length of a camera of the image sensor 107, edge and visual feature detection, and/or pixel coordinate and distance information may be used to analyze an image provided by image sensor 107 to determine dimensions and locations of vehicle, wheels, etc. The dimensions and location of vehicles, wheels, feature points, etc., in several images at several various times may be analyzed by the controller 101 to determine the other information movement, rotation, change of angle of the vehicles, wheels, feature points, etc.

The image information from the image sensor may be used to detect the wheels by drawing a bounding box around the wheel. For example, the wheel rim appears in the image as an ellipse or a circle with a vertical major axis and a horizontal minor axis. The axes are surrounded by a dark ellipse (e.g., a tire) with a major and minor axis. In one example, a “rough” bounding box is found using use a pre-trained deep neural network model, e.g. convolutional neural network (CNN). If a rough bounding box is already available or found, ellipse detection is performed in the region inside and slightly outside the rough bounding box and/or the position, height, width of the bounding box may be moved or adjusted in the image based on wheel unique features.

The wheel rim and the tire may and their corresponding ellipses/circles may be detected using edge or shape detection techniques. Feature points corresponding to the edge of the wheel, the edges of the tires, the spokes, and the intersection of the spokes and the edge of the wheel may be detected using shape, edge, and intersection detection methods.

Moreover, wheel rotation in the image frame is invariant to camera translation and camera orientation except for bank angle. For example, the top of wheel in the real world shows up as the top of the wheel in the image frame irrespective of camera translates. However, the bank angle does not vary too much at low speeds on smooth roads and the wheel rotation in the image frame caused by the bank angle change of the camera can be measured using an inertial measurement unit.

The communication device 108 may be used by the apparatus that detects the motion of a slow-moving vehicle 100 to communicate with several types of external apparatuses according to various communication methods. The communication device 108 may be used to send/receive information including information from the image sensor 107 such as image information, and the other types of information. The communication device 108 may also be configured to send information indicating that an external vehicle is moving and information corresponding to the movement of the external vehicle.

The communication device 108 may include various communication modules such as one or more from among a telematics unit, a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee.

According to an exemplary embodiment, the controller 101 of the apparatus that detects the motion of a slow-moving vehicle 100 may be configured to detect a wheel of the vehicle in a plurality of frames of a video, generate bounding boxes around portions of the frames including the wheel of the vehicle, scale the portions of the frames including the wheel of the vehicle to a predetermined constant size, determine whether the wheel of the vehicle is moving by analyzing the scaled portions of the frames, and output information indicating that the vehicle is moving if the determining determines that the wheel of the vehicle is moving. The wheel may include a plurality of wheels.

The controller 101 of the apparatus that detects the motion of a slow-moving vehicle 100 may be configured to determine whether the wheel of the vehicle is moving by determining whether the wheel of the vehicle is rotating and/or the direction of movement of the wheel.

The controller 101 of the apparatus that detects the motion of a slow-moving vehicle 100 may be configured to output information by controlling the output 104 to provide a notification indicating that the vehicle is moving if the determining determines that the vehicle is moving in a direction that will obstruct a path of a host vehicle.

The controller 101 may also be configured to analyze the scaled portions of the image by identifying a plurality of feature points corresponding to the wheel of the vehicle in the frames of the image and determining changes in coordinates of the plurality of features points in the frames of the image. The image information analyzed by the controller 101 to detect the wheels by drawing a bounding box around the wheel. For example, the wheel rim appears in the image as an ellipse or a circle with a vertical major axis and a horizontal minor axis. The axes are surrounded by a dark ellipse (e.g., a tire) with a major and minor axis. The wheel rim, the tire may and their corresponding ellipses/circles may be detected by the controller 101 using edge or shape detection techniques. Feature points corresponding to the edge of the wheel, the edges of the tires, the spokes, and the intersection of the spokes and the edge of the wheel may also be detected by the controller 101 using shape, edge, and intersection detection methods.

The controller 101 may also be configured to determine changes in coordinates of the plurality of features points in the frames of the image by calculating a change in angle with respect to the identified plurality of feature points.

The controller 101 may also be configured to analyze the scaled portions of the image by identifying a shape corresponding to the wheel of the vehicle in the frames of the image and determining changes in coordinates of the identified shape in the frames of the image. The controller 101 may also be configured to identify the shape by performing one or more from among edge detection, line detection, and ellipse or circle detection.

The controller 101 may also be configured to control the host vehicle controls 105 to stop the host vehicle or drive the host vehicle around a slow moving external vehicle if the controller determines that an external vehicle is moving in a direction that will obstruct a path of a host vehicle.

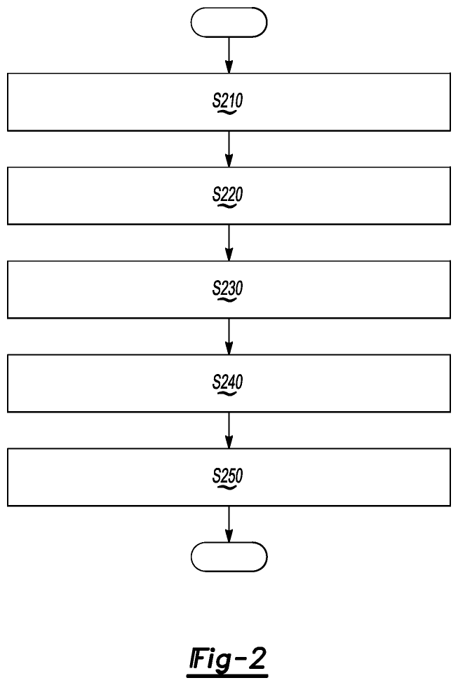

FIG. 2 shows a flowchart for a method of detecting motion of a slow-moving vehicle according to an exemplary embodiment. The method of FIG. 2 may be performed by the apparatus that detects the motion of a slow-moving vehicle 100 or may be encoded into a computer readable medium as instructions that are executable by a computer to perform the method.

Referring to FIG. 2, a wheel of an external vehicle in a plurality of frames of a video is detected in operation S210. For example, all wheels of all vehicles in the camera frame may be detected using vision or neural networks.

In operation S220, bounding boxes around portions of the frames including the wheel of the vehicle are generated. For example, bounding boxes may be generated around all wheels of all vehicles in the camera frame. The bounding box may be sized to precisely fit the wheel using ellipse detection methods. In one example, the frame may also be cropped to the bounding box. Further, bounding boxes of the frames may be matched with bounding boxes around corresponding wheels in a previous frame.

The portions of the frames including the wheel of the vehicle are scaled to a predetermined constant size in operation S230. If there are no corresponding bounding boxes around corresponding wheels in a previous frame, the process may add the detected wheel to the total number of wheels in the frame. It is then determined whether the wheel of the vehicle is moving by analyzing the scaled portions of the frames in operation S240.

In one example, the determination may be performed by detecting feature points of the wheel may be detected in the bounding box and the average wheel angle change may be determined as the average change in angle across all the feature points of the wheel from frame to frame. Based on the average wheel angle change, the rotation of the wheel in the bounding box may be determined. Alternatively, in another example, the frame containing the wheel may be input into a trained neural network, e.g., a RNN, a LSTM, GRU, etc., associated with the wheel to receive total wheel rotation angle change as output.

Then, in operation S250, information may be output indicating that the vehicle is moving if the wheel is moving. The wheel may be determined to be moving if the rotation of the wheel is greater than a predetermined threshold rotation. In operations 210-250, a plurality of wheels may be detected and the operations 210-250 may be performed with respect to a plurality of wheels

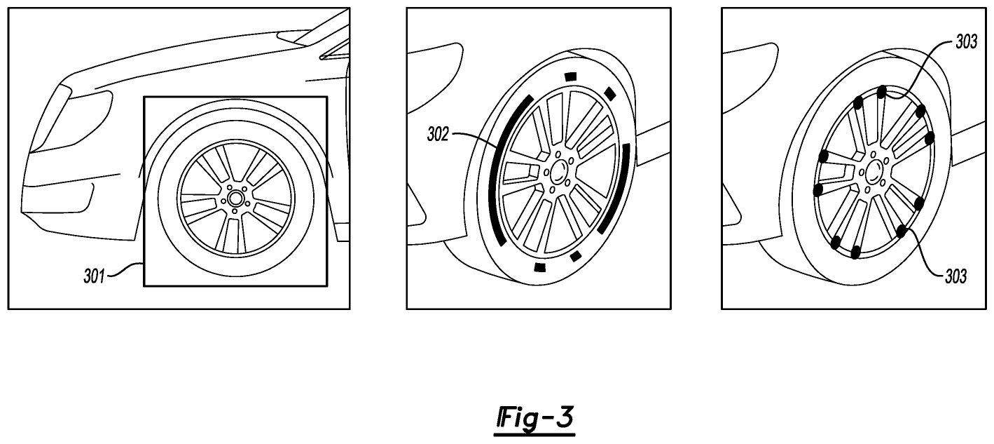

FIG. 3 shows an illustration of generating bounding boxes and identifying feature points on a wheel of a vehicle according to an aspect of an exemplary embodiment. Referring to FIG. 3, a bounding box 301 is generated around a wheel that is detected in image or frame.

The area is of the bounding box is then scaled and features points, shapes, or lines are detected. Features points 302 show lines outlining the shapes of the wheel and points showing where a spoke of a wheel intersects the edge of the wheel. Feature points 303 simply show points where a spoke of a wheel intersects the edge of the wheel

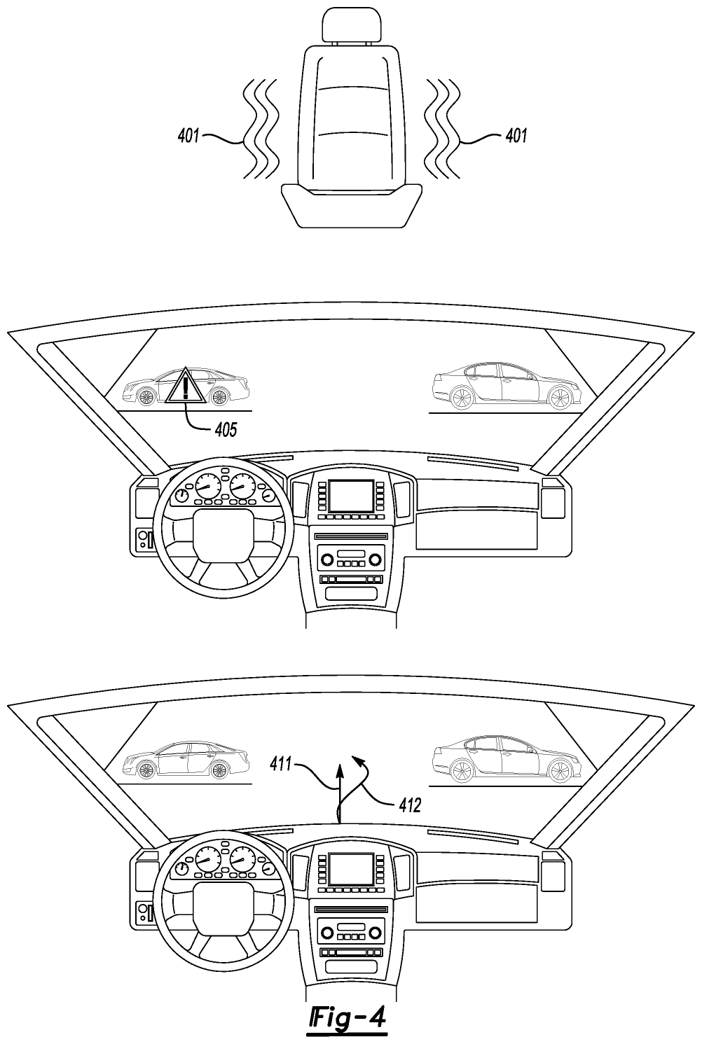

FIG. 4 shows illustrations of notifications warning of a slow-moving vehicle in a parking lot according to an aspect of an exemplary embodiment.

Referring to FIG. 4, haptic feedback provided in form of seat vibrations may be output in a host vehicle when a slow moving external vehicle is detected as illustrated in 401. The haptic feedback may be provided on the side of the seat that corresponds to a location of the external vehicle.

A warning graphical indicator 405 may be provided in an area of the display corresponding to the slow-moving vehicle to alert an occupant of a host vehicle to the external slow-moving vehicle. Further still, a driver of a host vehicle may be alerted of an undesirable path of a host vehicle 411 that may collide with the external vehicle via the display and a more desirable path 412 that would avoid a potential collision with the external vehicle may be displayed. Additionally, the more desirable path may be used by the host vehicle controls 105 control the vehicle to travel along the more desirable path.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A method for detecting motion of a slow-moving vehicle, the method comprising:
detecting a wheel of the vehicle in a plurality of frames of a video;
generating bounding boxes around portions of the frames including the wheel of the vehicle;
scaling the portions of the frames including the wheel of the vehicle to a predetermined constant size;
determining whether the wheel of the vehicle is moving by analyzing the scaled portions of the frames; and
outputting information indicating that the vehicle is moving if the determining determines that the wheel of the vehicle is moving.

2. The method of claim 1, wherein the determining whether the wheel of the vehicle is moving comprises determining whether the wheel of the vehicle is rotating.

3. The method of claim 2, wherein the determining whether the wheel of the vehicle is moving further comprises determining a direction of movement of the wheel.

4. The method of claim 1, wherein the outputting information comprises providing a notification indicating that the vehicle is moving if the determining determines that the vehicle is moving in a direction that will obstruct a path of a host vehicle.

5. The method of claim 4, wherein the notification comprises at least one from among displaying an alternate path for the host vehicle, haptic feedback via a seat in a host vehicle, and displaying a warning associated with the moving vehicle on a display in the host vehicle.

6. The method of claim 1, wherein the analyzing the scaled portions of the image comprises identifying a plurality of feature points corresponding to the wheel of the vehicle in the frames of the image and determining changes in coordinates of the plurality of features points in the frames of the image.

7. The method of claim 6, wherein the determining changes in coordinates of the plurality of features points in the frames of the image comprises calculating a change in angle with respect to the identified plurality of feature points.

8. The method of claim 1, wherein the analyzing the scaled portions of the image comprises identifying a shape corresponding to the wheel of the vehicle in the frames of the image and determining changes in coordinates of the identified shape in the frames of the image.

9. The method of claim 8, wherein the identifying the shape comprises performing one or more from among edge detection, line detection, and ellipse or circle detection.

10. The method of claim 1, further comprising controlling a host vehicle to change a path based on the information indicating that the vehicle is moving.

11. An apparatus that detects motion of a slow-moving vehicle, the apparatus comprising:
at least one memory comprising computer executable instructions; and
at least one processor configured to read and execute the computer executable instructions, the computer executable instructions causing the at least one processor to:
detect a wheel of the vehicle in a plurality of frames of a video;
generate bounding boxes around portions of the frames including the wheel of the vehicle;
scale the portions of the frames including the wheel of the vehicle to a predetermined constant size;
determine whether the wheel of the vehicle is moving by analyzing the scaled portions of the frames; and
output information indicating that the vehicle is moving if the determining determines that the wheel of the vehicle is moving.

12. The apparatus of claim 11, wherein the computer executable instructions cause the at least one processor to determine whether the wheel of the vehicle is moving by determining whether the wheel of the vehicle is rotating.

13. The apparatus of claim 12, wherein the computer executable instructions cause the at least one processor to determine whether the wheel of the vehicle is moving by determining a direction of movement of the wheel.

14. The apparatus of claim 11, wherein the computer executable instructions cause the at least one processor to output information by providing a notification indicating that the vehicle is moving if the determining determines that the vehicle is moving in a direction that will obstruct a path of a host vehicle.

15. The apparatus of claim 14, wherein the notification comprises at least one from among displaying an alternate path for the host vehicle, haptic feedback via a seat in a host vehicle, and displaying a warning associated with the moving vehicle on a display in the host vehicle.

16. The apparatus of claim 11, wherein the computer executable instructions further cause the at least one processor to analyze the scaled portions of the image by identifying a plurality of feature points corresponding to the wheel of the vehicle in the frames of the image and determining changes in coordinates of the plurality of features points in the frames of the image.

17. The apparatus of claim 16, wherein the computer executable instructions cause the at least one processor to determine changes in coordinates of the plurality of features points in the frames of the image by calculating a change in angle with respect to the identified plurality of feature points.

18. The apparatus of claim 11, wherein the computer executable instructions cause the at least one processor to analyze the scaled portions of the image by identifying a shape corresponding to the wheel of the vehicle in the frames of the image and determining changes in coordinates of the identified shape in the frames of the image.

19. The apparatus of claim 18, wherein the computer executable instructions cause the at least one processor to identify the shape by performing one or more from among edge detection, line detection, and ellipse or circle detection.

20. The apparatus of claim 11, wherein the wheel comprises a plurality of wheels.
